(19) United States
(12) Patent Application Publication
(10) Pub. No.: US 2013/0272190 A1
(43) Pub. Date: Oct. 17, 2013

(54) Dynamic Configuration of Relay Nodes in a Cellular Communication System

(71) Applicants: Lei Du, Beijing (CN); Shun Liang Zhang, Beijing (CN); Simone Redana, Munich (DE)

(72) Inventors: Lei Du, Beijing (CN); Shun Liang Zhang, Beijing (CN); Simone Redana, Munich (DE)

(73) Assignee: Nokia Siemens Networks Oy, Espoo (FI)

(21) Appl. No.: 13/994,804

(22) PCT Filed: Dec. 17, 2010
(86) PCT No.: PCT/CN2010/079925

§ 371 Date: Jun. 17, 2013

(51) Int. Cl. H04W 16/26

(52) U.S. Cl. CPC H04W 16/26
USPC 370/315

(57) ABSTRACT

An access node of a radio access network of a cellular communication system obtains first configuration information for at least one relay node which is capable of being wirelessly connected to the radio access network via the access node and is associated with the access node, wherein the first configuration information includes information on an interface between the access node and the at least one relay node, and transmits the first configuration information to at least one other access node of the radio access network. Alternatively or in addition, the access node receives second configuration information from the at least one other access node, for at least one other relay node which is capable of being wirelessly connected to the radio access network via the at least one other access node and is associated with the at least one other access node, wherein the second configuration information includes information on an interface between the at least one other access node and the at least one other relay node.

The present invention relates to a dynamic configuration of relay nodes in a cellular communication system.

Relaying is considered for LTE (long term evolution)—Advanced as a tool to improve e.g. coverage of high data rates, group mobility, temporary network deployment, cell-edge throughput and/or to provide coverage in new areas. In relaying, a user equipment or terminal (UE) is not directly connected with an access node such as a radio base station (e.g. denoted as eNodeB or eNB) of a radio access network (RAN), but via a relay node (RN).

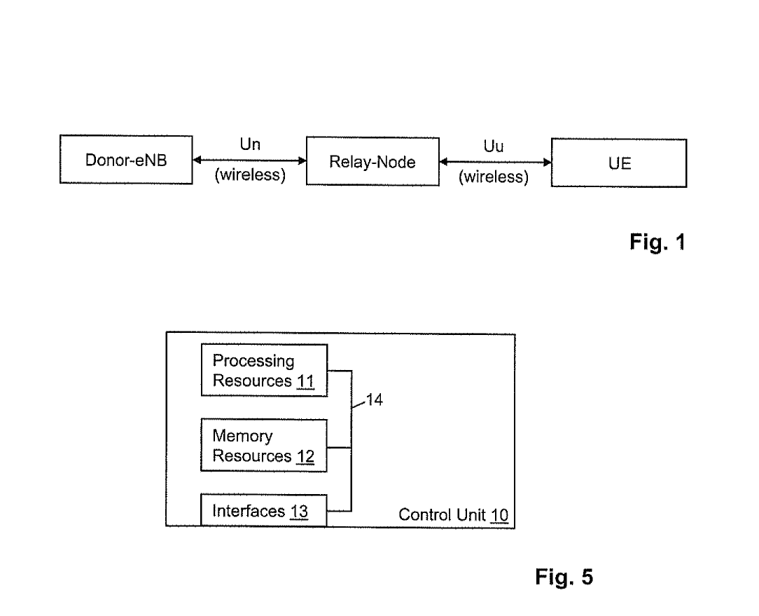

FIG. 1 shows an interface definition of a relaying system where a relay node (RN) is wirelessly connected to the radio access network via a donor cell or donor eNB (DeNB). The link between DeNB and RN is called backhaul link and the interface is named Un. The (wireless) link between RN and UE is called access link and the interface is named Uu. From the UE perspective it is like the (wireless) link between DeNB and UE, which is called direct link and named Uu interface as well.

Different types of operation modes of relay nodes (also referred to as RN types) can be defined depending on a frequency band of the access link and the backhaul link and how a cell is controlled. Examples of current RN types are type 1, type 1-a, type 1-b and type 2. RNs of type 1, type 1-a and type 1-b relay all control cells of their own, each of which appears to a UE as a separate cell distinct from the donor cell. In contrast, an RN of type 2 is part of the donor cell, i.e. it does not have a separate physical cell ID and cannot create any new cells. The classification and its features are identified as below:
RN type 1: The link between the DeNB and the RN (DeNB-RN link) shares the same carrier frequency with links between the RN and UEs (RN-UE links), i.e. the DeNB-RN link is in-band. Resource partitioning is applied between the Un and Uu interfaces. The RN has control cells of its own.
RN type 1a: The DeNB-RN link operates on a carrier frequency different from that of the RN-UE links, i.e. the DeNB-RN link is out-band. The RN has control cells of its own.
RN type 1b: The DeNB-RN link is in-band with adequate antenna isolation to the links between the RN and UEs (RN-UE links), i.e. without resource partitioning for the Un interface. The RN has control cells of its own.
RN type 2: The DeNB-RN link is in-band. The RN is part of a donor cell.

When an RN accesses a DeNB, it may indicate the preferred RN type or the RN types it supports to the DeNB so that a specific RN type can be decided and applied to the RN.

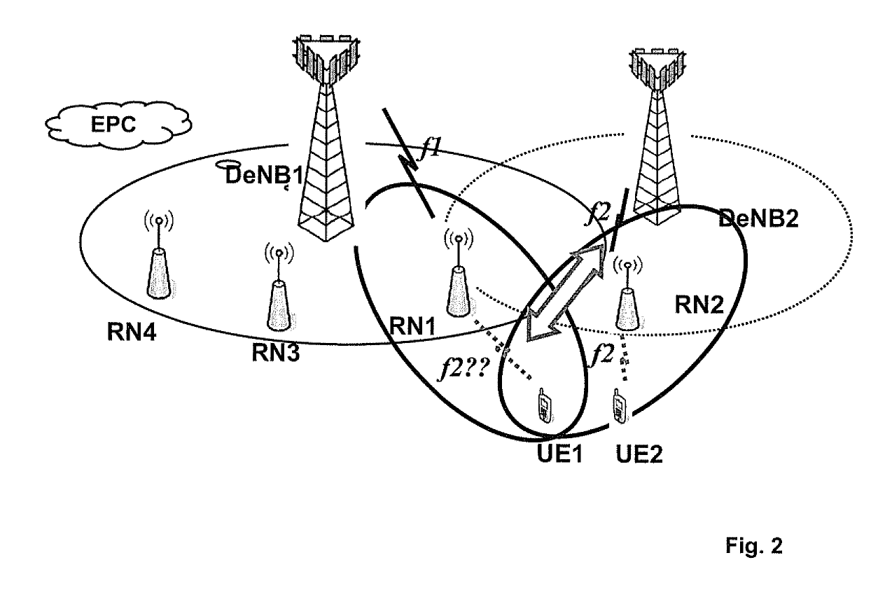

The following problems or part of them may be identified when an RN is supposed to support different RN types. As shown in FIG. 2, a relay node RN2 is connected to an access node DeNB2 and operates in a type 1 mode, i.e. shares the same carrier frequency f2 with its access node. If a relay node RN1 is connected to an access node DeNB1 and operates in a type 1a mode (out-band) over carrier frequency f2 for the access link (i.e. RN-UE link, Uu interface), this may cause severe interference between RN1-UE1 and DeNB2-RN2 links (which is also referred to as backhaul-access interference or RN-to-RN interference), which degrades performance of RN2 backhaul link in downlink and performance of RN1 access link in uplink. Thus, it should be avoided to select f2 exclusively for the access link when RN1 accesses DeNB1.

Another problem or part of it may arise when several RNs access the same DeNB. For example, if relay nodes RN1, RN3 and RN4 are all sharing the same band f1 for backhauling with DeNB1, performance may be degraded over DeNB1-UE link due to resource sharing between backhaul and direct links. It is more likely that the RNs will be configured to RN types that use different carrier frequencies for the access and backhaul links, e.g. operate in the type 1a mode, but this may bring more RN-to-RN interference to neighboring DeNBs/RNs as described above.

Moreover, when new RNs join a DeNB, reconfiguration of already active RNs may be carried out. For example, both relay nodes RN1 and RN2 are assumed to operate in type 1 mode and no RN-to-RN interference is detected. When RN3 and RN4 tend to access to the DeNB1 and attempt to select the type 1 mode, it is likely that the DeNB1 cannot afford the resources allocated to backhaul and then rearranges the operation mode of RN1 from type 1 to type 1a, which may bring more RN-to-RN interference to neighboring DeNBs/RNs as described above.

The present invention aims at solving the above problems or part of them and at properly arranging relay node configuration such that the overall performance of a cellular communication system is maximized with limited interference in the radio access network.

This can be achieved by the exemplary apparatuses and methods as defined in the appended claims. The invention may also be implemented by a computer program product.

According to an embodiment of the invention, negotiation of a selection of relay node types between access nodes of a radio access network of a cellular communication system is enabled. In this way, a proper RN type can be set based on a setting of neighboring RNs to minimize interference in-between and hence enhance the overall system performance.

With the present invention, dynamic configuration of relay nodes is provided in which DeNBs are enabled to control and limit RN-to-RN interference.

An aspect of the kind of self organizing network (SON) proposed by the present invention is the avoidance/limitation of RN-to-RN interference. Information on RN configurations distributed between access nodes can be used to improve inter-cell interference coordination (ICIC). The knowledge sharing between neighboring access nodes may lead to better utilization of resources and reduced interferences for users (i.e. user equipments) connected to relay nodes.

In case there is no information exchange between neighboring access nodes about their RNs or RN configurations, a system with high level of interference may be obtained, undoing the coverage/capacity benefit the RNs were supposed to bring to the system to begin with. With the invention, this problem or part of it can be mitigated to a large extent.

In the following the invention will be described by way of embodiments thereof taking into account the accompanying drawings, in which:

FIG. 1 shows a schematic diagram illustrating an interface definition of a relaying system.

FIG. 2 shows a schematic diagram illustrating a problem of RN configuration for RN types and frequency bands.

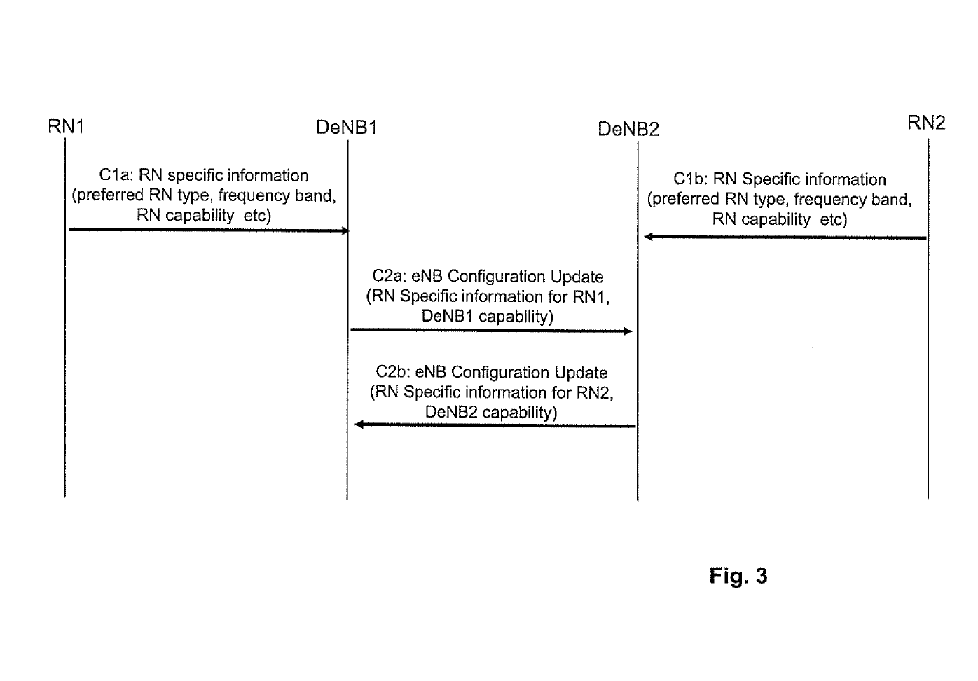

FIG. 3 shows a signaling diagram illustrating an exchange of configuration information between access nodes according to an embodiment of the invention.

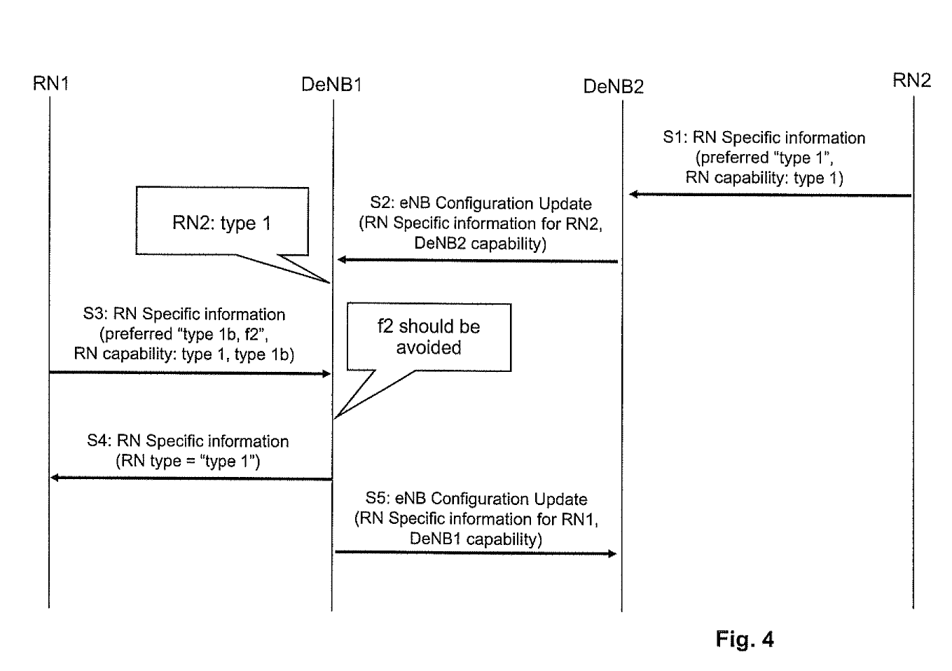

FIG. 4 shows a signaling diagram illustrating a configuration process of a relay node accessing an access node according to an embodiment of the invention.

FIG. 5 shows a schematic block diagram illustrating a structure of a control unit that may be used for practicing exemplary embodiments of the invention.

According to an embodiment of the invention, an access node of a radio access network of a cellular communication system, such as a donor eNodeB (DeNB), communicates with neighboring DeNBs configuration information comprising RN specific information of relay nodes which are associated with the DeNB, so that the neighboring DeNBs can use this information to configure proper specific parameters of their connected relay nodes for interference avoidance and performance enhancement. In particular, the RN specific information comprise information related to the Un interface illustrated in FIG. 1, i.e. which is relevant to a UE functionality resided in the relay node. The RN specific information may also comprise information related to the Uu interface illustrated in FIG. 1, e.g. a frequency band over RN-UE link.

Relay nodes which are associated with the access node may comprise relay nodes which are wirelessly connected to the access node and relay nodes which have disconnected from the access node.

The configuration information may include at least one of the following configuration parameters:
Type of operation mode in which the relay node (RN) associated with the access node is operating, i.e. an RN type comprising types 1, 1a, 1b and 2 or other types that will be defined in future.
Frequency bands used by the relay node associated with the access node over the Un interface and/or the Uu interface, i.e. an RN frequency band (or carrier frequency) which the relay node is using over the DeNB-RN and the frequency band (or carrier frequency) which the relay node is using over RN-UE links when operating out-band (RN type 1a); the latter parameter may be omitted when the RN is operating in-band (RN types 1 and 1b) since same frequency band is used for DeNB-RN and RN-UE.
Preferred type of operation mode of the relay node associated with the access node, i.e. the RN type in which the RN prefers to operate.
Preferred RN frequency band of the relay node associated with the access node, i.e. the frequency band (or carrier frequency) the RN prefers to use over the DeNB-RN and/or RN-UE links.
Types of operation modes and frequency bands supported by the relay node associated with the access node (also referred to as RN capability), i.e. the overall RN types and frequency bands (or carrier frequencies) that the RN can support, which may be informed from the RN to the DeNB during or after the RN is connected to the DeNB.
Multimedia broadcast/multicast service single frequency network (MBSFN) sub-frame configuration of sub-frames assigned to the Un interface (also referred to as MBSFN sub-frame configuration), i.e. sub-frames assigned to the Un interface for each relay node associated with the access node, in case of RN type 1.
Resource partitioning information, i.e. the total sub-frames assigned by the DeNB to the backhaul links (DeNB-RN links).
Frequency bands used by the access node over the Un interface and/or between the access node and user equipments (also referred to as DeNB frequency band), i.e. the frequency bands (or carrier frequencies) the DeNB is using over DeNB-UE and DeNB-RN links.
Types of operation modes of relay nodes supported by the access node and frequency bands supported by the access node (also referred to as DeNB capability), i.e. the RN types that can be supported by the DeNB, such as type 1, type 2, type 1a and/or the frequency band (or carrier frequency) that can be supported on the Un interface, and type 1b (the DeNB may support one or more types of relay (RN types)), and the overall frequency bands (or carrier frequencies) the DeNB can support over DeNB-UE and DeNB-RN links.
Maximum allowable transmit power for the relay node associated with the access node, i.e. the maximum transmit power the RN can use to communicate with the DeNB.

It is to be noted that different or further parameters and/or parameters that will be defined in future may be used for the configuration information. The above parameters are examples and are not to be construed as limiting the present invention thereto.

When an RN is accessing to a DeNB, the DeNB decides a configuration for the RN which includes at least one of the following parameters:
RN type,
DeNB-RN link carrier frequency,
RN-UE link carrier frequency,
resource partitioning,
MBSFN sub-frame configuration, and
Maximum allowable transmit power for the RN.

The DeNB may decide the configuration under consideration of configuration information received from neighboring DeNBs. The DeNB may also base the decision on configuration information derived from relay nodes within its coverage (the relay nodes which are associated with the DeNB). The neighboring DeNBs may be access nodes which are adjacent to the DeNB with respect to the geographical structure of the radio access network. Alternatively or in addition, the neighboring DeNBs may be access nodes which have connected thereto a relay node which is likely to interfere with a relay node of the DeNB.

The DeNB may be able to reconfigure the RNs associated to it based on the configuration information received from neighboring DeNBs.

Moreover, the DeNB may be able to change its own relay operation mode (for example, change from resource partitioning to no resource partitioning) based on the configuration information exchanged with its neighboring DeNBs.

FIG. 3 shows signaling in which DeNBs exchange configuration information comprising RN specific information according to an embodiment of the invention.

In a communication C1a, a relay node RN1 sends its RN specific information to a DeNB1 with which the RN1 is associated. Similarly, in a communication C1b, a relay node RN2 sends its RN specific information to a DeNB2 with which the RN2 is associated. The DeNB1 and DeNB1 are access nodes of a radio access network of a cellular communication system. The RN specific information may comprises at least part of the parameters of the configuration information listed above.

The RN specific information may be included in a radio resource control (RRC) connection request message and/or an RRC connection setup complete message during an RRC connection procedure between the respective RN and the DeNB, or can be notified ₜo the DeNB after the connection is set up, e.g. in a UE capability message, a non access stratum (NAS) message, or a new message from RN to DeNB.

The DeNB1 sends the RN specific information of the RN1 to the DeNB2 as another access node of the radio access network in a communication C2a. Only one relay node is shown in FIG. 3, but the DeNB1 may send RN specific information for each of relay nodes associated with it to the DeNB2. The DeNB1 may also send further information to the DeNB2 including parameters of the configuration information listed above, e.g. DeNB capability. Only one other access node DeNB2 is shown in FIG. 3, but there may be several other access nodes to which the DeNB1 may send the RN specific information and/or the further information. The other access nodes may be neighboring access nodes to which relay nodes are connected that are likely to interfere with a relay node associated with the DeNB1.

The DeNB1 may send the RN specific information and/or the further information to the DeNB2 via an X2 interface provided between access nodes, e.g. using an eNB configuration update message. Sending of the RN specific information and/or the further information from the DeNB1 to the DeNB2 may be triggered immediately after an RN successfully accesses to the DeNB1, when an RN successfully disconnects from the DeNB1, when the RN specific information corresponding to an RN is updated or reconfigured by the DeNB1, and/or when a new neighbor DeNB is detected. In case that an RN disconnects from the DeNB1, a blank message or a dedicated message may be define to indicate that the RN is not connected to the DeNB1.

Furthermore, sending of the RN specific information and/or the further information from the DeNB1 to the DeNB2 maybe triggered only when an RN connected to the DeNB1 has neighbor relationship with an RN connected to the DeNB2, i.e. when the RN of the other access node is likely to interfere with the RN of the DeNB1. For example, referring to FIG. 2, a joining/quit/update of RN3 and RN4 should not trigger sending RN3/RN4 specific information from DeNB1 to DeNB2 in case only RN1 has a neighbor relationship with RN2 under DeNB2. As a result, unnecessary signaling over both backhaul link and X2 interface can be avoided.

According to FIG. 3, the DeNB2 sends the RN specific information of the RN2 to the DeNB1 in a communication C2b. The DeNB2 may also send further information to the DeNB1 including parameters of the configuration information listed above, e.g. DeNB capability. The further explanations provided above with respect to the DeNB1 also apply to the DeNB2.

With the above procedure, communications between relay nodes and associated access nodes, for example, as well as other communications and information can be shared between neighboring access nodes.

FIG. 4 shows an example of an RN accessing a DeNB and being configured, according to an embodiment of the invention.

In a step S1, a relay node RN2 informs an access node DeNB2 of its capability to support RN type 1 only on a carrier frequency f2, and hence indicates its preferred RN type as “type 1”. This information may be included in RN specific information sent from the RN2 to the DeNB2 in an access request.

In a step S2, the DeNB2 evaluates the access request and agrees to configure the RN2 as RN type 1, and includes the RN specific information for RN2 and a DeNB2 capability, e.g. supporting RN type 1 only, in an eNB configuration update message to a DeNB1 which is a neighboring access node of the DeNB2. At this moment, the DeNB1 knows that RN2 is associated with DeNB2 and operates in RN type 1 on the carrier frequency f2.

In a step S3, when a relay node RN1 requests access to the DeNB1, it informs the DeNB1 of its capability to support RN type 1 and RN type 1b on carrier frequency f2 for both operation modes, and also its preferred RN type as “type 1b on f2”. This information may be included in RN specific information sent from the RN1 to the DeNB1 in the access request.

In a step S4, the DeNB1 evaluates the access request and finds that the carrier frequency f2 is also used by the RN2 neighboring to the RN1 which may cause RN-to-RN interference. Hence, the DeNB1 suggests RN type 1 (the same mode of operation as RN2) for RN1 to avoid interference and informs the RN1 accordingly in RN specific information sent from the DeNB1 to the RN1.

In a step S5, the DeNB1 sends RN specific information for the RN1 to the DeNB2 via an eNB configuration update message together with a DeNB1 capability, thereby informing the DeNB2 about the configuration of the RN1.

Thus, the DeNB1 may determine the configuration for the RN1 based on configuration information (i.e. RN specific information and/or access node specific information) received from the DeNB2. Furthermore, the DeNB1 may change the configuration for the relay nodes associated with the DeNB1 based on the configuration information. Similarly, the DeNB2 may change a configuration of its relay nodes based on configuration information received from the DeNB1.

Referring to the scenario illustrated in FIG. 2, according to the present invention the rearrangement of the operation mode of RN1 from type 1 to type 1a can be communicated from the DeNB1 to the

DeNB2, so that the DeNB2 is able to reconfigure properly the operation mode of RN2, e.g. to type 1a as well, to avoid the interference between the RN1-UE1 and DeNB2-RN2 links as well as between RN2-UE2 and DeNB1-RN1 links.

FIG. 5 illustrates a simplified block diagram of a control unit 10 that may be used in the above relay nodes and access nodes, respectively, for practicing the exemplary embodiments of the invention.

The control unit 10 includes processing resources 11, memory resources 12 that may store a program, and interfaces 13 which may include a suitable radio frequency transceiver coupled to one or more antennas for bidirectional wireless communications over one or more wireless links. The processing resources 11, memory resources 12 and interfaces 13 may be coupled by a bus 14.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

Programs stored by the memory resources 12 are assumed to include program instructions that, when executed by the associated processing resources 11, enable the control unit 10 used in the relay nodes and access nodes, respectively, to operate in accordance with the exemplary embodiments and aspects of this invention. Inherent in the processing resources 11 is a clock to enable synchronism among the various apparatus for transmissions and receptions within the appropriate time intervals and slots required, as the scheduling grants and the granted resources/subframes are time dependent. The transceivers of the interfaces 13 include both transmitter and receiver, and inherent in each is a modulator/demodulator commonly known as a modem. The interfaces 13 may also include a modem to facilitate communication over (hardwire) links.

In general, the exemplary embodiments of this invention may be implemented by computer software stored in the memory resources 12 and executable by the processing resources 11, or by hardware, or by a combination of software and/or firmware and hardware in any or all of the devices shown.

The memory resources 12 may be of any type suitable to the local technical environment and may be implemented using any suitable data storage technology, such as semiconductor-based memory devices, magnetic memory devices and systems, optical memory devices and systems, fixed memory and removable memory. The processing resources 11 may be of any type suitable to the local technical environment, and may include one or more of general purpose computers, special purpose computers, microprocessors, digital signal processors (DSPs) and processors based on a multi-core processor architecture, as non-limiting examples.

For example, the control unit 10 may function as part of elements of the respective relay node shown in FIGS. 3 and 4. The control unit 10 with its processing resources 11, memory resources 12 and interfaces 13 may be used to implement the functionality of the respective relay node as described above. For example, the processing resources 11 may execute steps C1a/C1b, S1/S3, using the memory resources 12 e.g. for reading out processing instructions corresponding to the steps, caching and storing processing results, and the interfaces 13 e.g. for receiving/transmitting the messages from/to the respective access node. Alternatively or in addition, the steps may be implemented by hardware in the processing resources 11, as mentioned above.

Moreover, the control unit 10 may function as part of elements of the respective access node shown in FIGS. 3 and 4. The control unit 10 with its processing resources 11, memory resources 12 and interfaces 13 may be used to implement the functionality of the respective access node as described above. For example, the processing resources 11 may execute steps C2a/C2b, S2/S4, S5, using the memory resources 12 e.g. for reading out processing instructions corresponding to the steps, caching and storing processing results, and the interfaces 13 e.g. for receiving/transmitting the messages from/to the respective relay node and other access node. Alternatively or in addition, the steps may be implemented by hardware in the processing resources 11, as mentioned above.

According to the present invention as described above, RN configuration information can be exchanged between DeNBs. RNs communicate their capability to their DeNBs, and the DeNBs decide a configuration (e.g. best mode of operation) for the RNs in order to reduce interference between the RNs and also between RNs and direct UEs. According to an embodiment of the invention, the neighbor DeNBs are made to exchange e.g. RN type information so that the DeNBs are able to make a smart decision on what kind of resources should be allocated to access links.

According to an aspect of the invention, an apparatus comprises obtaining means for obtaining first configuration information for at least one relay node which is capable of being wirelessly connected to a radio access network of a cellular communication system via the apparatus and is associated with the apparatus which is an access node of the radio access network, wherein the first configuration information comprises information on an interface between the apparatus and the at least one relay node, and transmitting means for transmitting the first configuration information to at least one other access node of the radio access network.

The transmitting means may transmit the first configuration information from the apparatus to the at least one other access node of the radio access network to share the first configuration information between the apparatus and the at least one other access node.

The apparatus may comprise first receiving means for receiving at least part of the first configuration information from the at least one relay node.

The first receiving means may receive the at least part of the first configuration information in a radio resource control connection request message during a radio resource control connection procedure between the apparatus and the at least one relay node and/or a radio resource control connection setup complete message during the radio resource control connection procedure and/or in a user equipment capability message and/or a non access stratum message and/or a new message.

The transmitting means may transmit the first configuration information at a time when a relay node has achieved access to the apparatus and/or when a relay node is disconnected from the apparatus and/or when the first configuration information for the at least one relay node is changed by changing means of the apparatus and/or when the at least one other access node is detected by detecting means of the apparatus.

The transmitting means may transmit the first configuration information to the at least one other access node in case the at least one relay node has a neighbor relationship to a relay node connected to the at least one other access node.

Alternatively or in addition, the apparatus comprises second receiving means for receiving second configuration information from the at least one other access node, for at least one other relay node which is capable of being wirelessly connected to the radio access network via the at least one other access node and is associated with the at least one other access node, wherein the second configuration information comprises information on an interface between the at least one other access node and the at least one other relay node.

The second receiving means may receive the second configuration information at the apparatus from the at least one other access node to share the second configuration information between the apparatus and the at least one other access node.

The apparatus may comprise determining means for determining a configuration for the at least one relay node based on the second configuration information and/or changing means for changing the configuration for the at least one relay node based on the second configuration information.

The transmitting means/second receiving means may transmit/receive the first/the second configuration information in access node configuration update messages, and the access node configuration update messages via an X2 interface between the apparatus and the at least one other access node.

The first and/or second configuration information may include at least one of the following configuration parameters:
a type of operation mode in which the at least one relay node and/or the at least one other relay node operates,
a frequency band used over the interface between the at least one relay node and/or the at least one other relay node and the apparatus/at least one other access node, and/or a frequency band used between the at least one relay node/at least one other relay node and at least one user equipment wirelessly connected to the at least one relay node/at least one other user equipment wirelessly connected to the at least one other relay node,
a preferred type of operation mode of the at least one relay node and/or the at least one other relay node,
a preferred frequency band of the at least one relay node and/or the at least one other relay node,
types of operation modes and frequency bands supported by the at least one relay node and/or the at least one other relay node,
multimedia broadcast/multicast service single frequency network sub-frame configuration of sub-frames assigned to the interface,
resource partitioning information,
frequency bands used over the interface between the apparatus and/or the at least one other access node and the at least one relay node/at least one other relay node, and/or frequency bands used between the apparatus and/or the at least one other access node and user equipments,
types of operation modes of relay nodes supported by the apparatus and/or the at least one other access node and frequency bands supported by the apparatus and/or the at least one other access node, and
a maximum allowable transmit power for the at least one relay node and/or the at least one other relay node.

The apparatus may comprise the DeNB1 and/or the DeNB2 shown in FIGS. 3 and 4. For example, the above means of the apparatus are implemented by the processing resources, memory resources and interfaces of the control unit of FIG. 5 as described above.

According to an aspect of the invention, an apparatus comprises transmitting means for transmitting at least part of configuration information for the apparatus to an access node of a radio access network of a cellular communication system, with which the apparatus is wirelessly connected, wherein the apparatus is a relay node which serves to connect at least one user equipment which is wirelessly connected to the apparatus to the radio access network, wherein the at least part of the configuration information comprises information on an interface between the apparatus and the access node and/or on an interface between the apparatus and the at least one user equipment.

The apparatus may comprise the RN1 and/or the RN2 shown in FIGS. 3 and 4. For example, the above means of the apparatus are implemented by the processing resources, memory resources and interfaces of the control unit of FIG. 5 as described above.

According to an embodiment of the invention, an access node of a radio access network of a cellular communication system obtains first configuration information for at least one relay node which is capable of being wirelessly connected to the radio access network via the access node and is associated with the access node, wherein the first configuration information comprises information on an interface between the access node and the at least one relay node, and transmits the first configuration information to at least one other access node of the radio access network. Alternatively or in addition, the access node receives second configuration information from the at least one other access node, for at least one other relay node which is capable of being wirelessly connected to the radio access network via the at least one other access node and is associated with the at least one other access node, wherein the second configuration information comprises information on an interface between the at least one other access node and the at least one other relay node.

It is to be understood that the above description is illustrative of the invention and exemplifies the invention, and is not to be construed as limiting the invention. Various modifications and applications may occur to those skilled in the art without departing from the true spirit and scope of the invention as defined by the appended claims.

1. An apparatus comprising:
a control unit configured to
obtain first configuration information for at least one relay node which is capable of being wirelessly connected to a radio access network of a cellular communication system via the apparatus and is associated with the apparatus which is an access node of the radio access network, wherein the first configuration information comprises information on an interface between the apparatus and the at least one relay node, and
transmit the first configuration information to at least one other access node of the radio access network.

2. The apparatus of claim 1, wherein the control unit is configured to receive at least part of the first configuration information from the at least one relay node.

3. The apparatus of claim 2, wherein the control unit is configured to receive the at least part of the first configuration information in a radio resource control connection request message during a radio resource control connection procedure between the apparatus and the at least one relay node and/or a radio resource control connection setup complete message during the radio resource control connection procedure and/or in a user equipment capability message and/or a non access stratum message and/or a new message.

4. The apparatus of claim 1, wherein the control unit is configured to transmit the first configuration information at a time when a relay node has achieved access to the apparatus and/or when a relay node is disconnected from the apparatus and/or when the first configuration information for the at least one relay node is changed by the control unit and/or when the at least one other access node is detected by the control unit.

5. The apparatus of claim 1, wherein the control unit is configured to transmit the first configuration information to the at least one other access node in case the at least one relay node has a neighbor relationship to a relay node connected to the at least one other access node.

6. The apparatus of claim 1, wherein the control unit is configured to
receive second configuration information from the at least one other access node, for at least one other relay node which is capable of being wirelessly connected to the radio access network via the at least one other access node and is associated with the at least one other access node, wherein the second configuration information comprises information on an interface between the at least one other access node and the at least one other relay node and
determine a configuration for the at least one relay node based on the second configuration information and/or change the configuration for the at least one relay node based on the second configuration information.

7. (canceled)

8. (canceled)

9. The apparatus of claim 6, wherein the control unit is configured to transmit/receive the first/the second configuration information in access node configuration update messages, and the control unit is configured to transmit/receive the access node configuration update messages via an X2 interface between the apparatus and the at least one other access node.

10. The apparatus of claim 1, wherein the first and/or second configuration information include at least one of the following configuration parameters:
a type of operation mode in which the at least one relay node and/or the at least one other relay node operates,
a frequency band used over the interface between the at least one relay node and/or the at least one other relay node and the apparatus/at least one other access node, and/or a frequency band used between the at least one relay node/at least one other relay node and at least one user equipment wirelessly connected to the at least one relay node/at least one other user equipment wirelessly connected to the at least one other relay node,
a preferred type of operation mode of the at least one relay node and/or the at least one other relay node,
a preferred frequency band of the at least one relay node and/or the at least one other relay node,
types of operation modes and frequency bands supported by the at least one relay node and/or the at least one other relay node,
multimedia broadcast/multicast service single frequency network sub-frame configuration of sub-frames assigned to the interface,
resource partitioning information,
frequency bands used over the interface between the apparatus and/or the at least one other access node and the at least one relay node/at least one other relay node, and/or frequency bands used between the apparatus and/or the at least one other access node and user equipments,
types of operation modes of relay nodes supported by the apparatus and/or the at least one other access node and frequency bands supported by the apparatus and/or the at least one other access node, and
a maximum allowable transmit power for the at least one relay node and/or the at least one other relay node.

11. The apparatus of claim 1, wherein the control unit is configured to transmit the first configuration information from the apparatus to the at least one other access node of the radio access network to share the first configuration information between the apparatus and the at least one other access node, and/or the control unit is configured to receive the second configuration information at the apparatus from the at least one other access node to share the second configuration information between the apparatus and the at least one other access node.

12. (canceled)

13. A method comprising:
obtaining first configuration information for at least one relay node which is capable of being wirelessly connected to a radio access network of a cellular communication system via an access node of the radio access network and is associated with the access node, wherein the first configuration information comprises information on an interface between the access node and the at least one relay node, and
transmitting the first configuration information to at least one other access node of the radio access network.

14. The method of claim 13, comprising:
receiving at least part of the first configuration information from the at least one relay node.

15. The method of claim 14, wherein the at least part of the first configuration information is received in a radio resource control connection request message during a radio resource control connection procedure between the access node and the at least one relay node and/or a radio resource control connection setup complete message during the radio resource control connection procedure and/or in a user equipment capability message and/or a non access stratum message and/or a new message.

16. The method of claim 13, comprising:
transmitting the first configuration information at a time when a relay node has achieved access to the access node and/or when a relay node is disconnected from the access node and/or when the first configuration information for the at least one relay node is changed by the access node and/or when the at least one other access node is detected by the access node.

17. The method of claim 13, comprising:
transmitting the first configuration information to the at least one other access node in case the at least one relay node has a neighbor relationship to a relay node connected to the at least one other access node.

18. The method of claim 13, comprising:
receiving second configuration information from the at least one other access node, for at least one other relay node which is capable of being wirelessly connected to the radio access network via the at least one other access node and is associated with the at least one other access node, wherein the second configuration information comprises information on an interface between the at least one other access node and the at least one other relay node and
determining a configuration for the at least one relay node based on the second configuration information and/or change the configuration for the at least one relay node based on the second configuration information.

19. (canceled)

20. (canceled)

21. The method of claim 18, wherein the first/the second configuration information are transmitted/received in access node configuration update messages, and the access node configuration update messages are transmitted/received via an X2 interface between the access node and the at least one other access node.

22. The method of claim 13, wherein the first and/or second configuration information include at least one of the following configuration parameters:
a type of operation mode in which the at least one relay node and/or the at least one other relay node operates,
a frequency band used over the interface between the at least one relay node and/or the at least one other relay node and the at least one access node/at least one other access node, and/or a frequency band used between the at least one relay node/at least one other relay node and at least one user equipment wirelessly connected to the at least one relay node/at least one other user equipment wirelessly connected to the at least one other relay node,
a preferred type of operation mode of the at least one relay node and/or the at least one other relay node,
a preferred frequency band of the at least one relay node and/or the at least one other relay node,
types of operation modes and frequency bands supported by the at least one relay node and/or the at least one other relay node,
multimedia broadcast/multicast service single frequency network sub-frame configuration of sub-frames assigned to the interface,
resource partitioning information,
frequency bands used over the interface between the access node and/or the at least one other access node and the at least one relay node/at least one other relay node, and/or frequency bands used between the access node and/or the at least one other access node and user equipments,
types of operation modes of relay nodes supported by the access node and/or the at least one other access node and frequency bands supported by the access node and/or the at least one other access node, and
a maximum allowable transmit power for the at least one relay node and/or the at least one other relay node.

23. The method of claim 13, wherein the first configuration information is transmitted from the access node to the at least one other access node of the radio access network to share the first configuration information between the access node and the at least one other access node, and/or the second configuration information is received at the access node from the at least one other access node to share the second configuration information between the access node and the at least one other access node.

24. (canceled)

25. A computer program product including a program for a processing device, comprising software code portions for performing the steps of claim 13 when the program is run on the processing device and
wherein the computer program product comprises a computer-readable medium on which the software code portions are stored.

26. (canceled)

27. The computer program product according to claim 25, wherein the program is directly loadable into an internal memory of the processing device.
